(19) United States
(12) Patent Application Publication
(10) Pub. No.: US 2006/0023911 A1
(43) Pub. Date: Feb. 2, 2006

(54) Combination monitor and microphone apparatus and methods therefor

(76) Inventor: Chris Eagan, Las Vegas, NV (US)

Correspondence Address: WEISS & MOY PC, 4204 NORTH BROWN AVENUE, SCOTTSDALE, AZ, 85251, US

(21) Appl. No.: 10/900,434

(22) Filed: Jul. 28, 2004

(51) Int. Cl. H04R 9/08; H04R 11/04; H04R 17/02

(52) U.S. Cl. 381/362; 381/363; 381/366

(57) ABSTRACT

A combination monitor and microphone apparatus comprises a microphone, a boom assembly, and a monitor assembly which includes boom clamping means located on the monitor assembly for coupling the monitor assembly to an opposite end of a second boom portion of the boom assembly. The boom clamping means is adapted to axially rotate the boom assembly and the monitor assembly has a housing which accomodates the microphone when the apparatus is not used by a performer. The boom assembly of the apparatus is selectively rotated in a direction to permit the performer to listen to sound emanating from a speaker and to permit at least one other person to listen to sound emanating from the speaker when the boom assembly is rotated in another direction during a performance.

### FIELD OF THE INVENTION

This invention relates generally to monitor stands used on a stage and more specifically to an improved combination monitor and microphone apparatus having a boom assembly which may be rotated to permit a performer or another person to listen to sound emanating from a speaker embedded in a monitor assembly of the combination monitor and microphone apparatus during a performance.

### BACKGROUND OF THE INVENTION

Sound monitors are commonly used on a stage to permit a performer to hear sounds that are heard by an audience during a performance. Sound monitors look like speakers enclosed in a large housing. The sound is usually fed to the performer via a public address system and may include a vocal component signal, as well as a portion of the instrument component signals emanating from the stage. It is common for a number of sound monitors to be placed on the stage, each one of the sound monitors being used by each performer on the stage. Current sound monitors are usually heavy and not easily moved around the stage. Often sound emanating from the sound monitor is distorted because of the power amplification and various frequencies that overlap during the performance both from the live sound and the amplified sound. At times this makes it difficult for the performer to distinguish the sounds emanating from the sound monitor.

With current sound monitors, after a performance is completed, the microphone and a stand commonly having a boom coupled to the microphone are usually left in place near the sound monitor and must be moved separately from the sound monitor. The sound monitor than must be separately moved which is a drain on space and is awkward to accomplish because of the size of the sound monitor and the stand.

Hacker, U.S. Pat. No. 6,487,298 discloses a microphone stand monitor which allegedly alleviates some of the difficulties inherent in using current sound monitors. Hacker's '298 disclosure has a sound monitor bolted on a microphone stand. The sound monitor is located between a microphone at one end of the microphone stand and a bottom portion of the microphone stand which is placed on the stage. The sound monitor is located sufficiently closely to the performer so that the combined microphone stand and the sound monitor may be top heavy leading to a real possibility that the combined microphone stand and the sound monitor may topple over. In addition, because of the proximity of the sound monitor to the performer, the sound monitor may experience feedback at certain sound levels which would be distracting to the audience as well as the performer. A sound monitor on a stage obviates this difficulty.

The present inventor has recognized the need for an improved combination monitor and microphone apparatus in which the monitor is located on a portion of a stage. In addition, the present inventor has recognized that such a combined monitor and microphone apparatus should be sufficiently portable so that the apparatus may be readily moved around and also off the stage. Moreover, the present inventor has recognized that a combined monitor and microphone apparatus should be able to be easily redeployed so that another person may also listen to the sound emanating from the apparatus while a performer continues to use a microphone coupled to the apparatus.

### SUMMARY OF THE INVENTION

Accordingly, it is an object of this disclosure to provide an improved combined monitor and microphone apparatus.

It is a further object of this disclosure to provide an improved combined monitor and microphone apparatus comprising a monitor assembly and a boom assembly coupled to the monitor assembly, so that the monitor assembly may be readily repositioned while permitting a performer to continue to use a microphone coupled to the boom assembly.

It is a still further object of this disclosure to provide an improved combined monitor and microphone apparatus comprising at least one clip located on a portion of the combined monitor and microphone apparatus for holding a boom assembly.

It is a yet further object of this disclosure to provide an improved combined monitor and microphone apparatus comprising a housing located in a portion of the combined monitor and microphone apparatus for holding a microphone when the combined monitor and microphone apparatus is not in use.

It is a further object of this disclosure to provide methods for using an improved combined monitor and microphone apparatus.

It is a yet further object of this disclosure to provide methods for storing a boom assembly and a microphone of an improved combined monitor and microphone apparatus after completion of a performance.

### PREFERRED EMBODIMENTS OF THE INVENTION

In accordance with one embodiment of this invention, a combination monitor and microphone apparatus is disclosed. The combination monitor and microphone apparatus comprises, in combination, a microphone, a boom assembly having a first boom portion and a second boom portion coupled to the microphone and clamping means located at one end of the first boom portion for permitting selective coupling to the microphone and an opposite end of the first boom portion that is telescopically coupled to one end of the second boom portion. The combination monitor and microphone apparatus further comprises a monitor assembly including boom clamping means located on a portion of the monitor assembly for coupling the monitor assembly to an opposite end of the second boom portion, the boom clamping means adapted to axially rotate the boom assembly. The monitor assembly of the combination monitor and microphone apparatus has a housing located in a portion of the monitor assembly, the housing accommodating at least a portion of the microphone when the combination monitor and microphone apparatus is not used by a performer. The monitor assembly also has a speaker located on a portion of the monitor assembly. The boom assembly of the combination monitor and microphone apparatus is selectively rotated in a direction to permit the performer to listen to sound emanating from the speaker such as during a performance and to permit at least one other person to listen to sound emanating from the speaker when the boom assembly is rotated in another direction. An inner portion of the opposite end of the second boom portion includes a vibration dampening material. The speaker of the monitor assembly is coupled to an inner portion of the monitor assembly and the inner portion of the monitor assembly includes a vibration dampening material.

In accordance with a second embodiment of this invention, a method for permitting a performer and at least one other person to listen to sound emanating from a combination monitor and microphone apparatus is disclosed. The method comprises the steps of providing a microphone, providing a boom assembly having a first boom portion and a second boom portion coupled to the microphone, providing clamping means located at one end of the first boom portion for permitting selective coupling to the microphone and an opposite end of the first boom portion that is telescopically coupled to one end of the second boom portion. The method further comprises the steps of providing a monitor assembly including boom clamping means located on a portion of the monitor assembly for coupling the monitor assembly to an opposite end of the second boom portion, the boom clamping means adapted to axially rotate the boom assembly. The method further comprises the steps of providing a housing located in a portion of the monitor assembly, the housing accommodating at least a portion of the microphone when the combination monitor and microphone apparatus is not used by a performer, providing a speaker located on a portion of the monitor assembly, selectively rotating the boom assembly in a direction to permit the performer to listen to sound emanating from the speaker such as during a performance and selectively rotating the boom assembly in another direction to permit at least the one other person to listen to sound emanating from the speaker. The method further comprises the steps of providing the housing has a cover for retaining the microphone in the housing thereby enclosing at least a portion of the microphone in the housing, retrieving the microphone from the housing for use during a performance and replacing the microphone in the housing after completion of the performance.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective view showing a combination monitor and microphone apparatus according to the present invention.

FIG. 2 is a perspective view showing a portion of a monitor assembly and a portion of a boom assembly of the combination monitor and microphone apparatus of FIG. 1 with alternative views of an opposite end of the boom assembly in position to couple to boom clamping means on a portion of the monitor assembly and with the boom assembly coupled to a plurality of clips on a portion of the monitor assembly when the boom assembly is not in use.

FIG. 3 is a sectional view of an inner portion of the opposite end of the boom assembly of FIG. 2 through 3-3 showing a vibration dampening material located in the inner portion of the opposite end of the boom assembly.

FIG. 4 is a sectional view of the monitor assembly of FIG. 2 through 4-4 showing an inner portion of the monitor assembly coupled to a speaker, an inner portion of the monitor assembly including a vibration dampening material and a portion of the monitor assembly comprising a housing for retaining a microphone.

FIG. 4A is an elevational view of a portion of a bottom side of the monitor assembly of FIG. 2 showing a portion of the inner portion of the monitor assembly (shown as dashed lines) and a cover for accessing the housing located in a portion of the monitor assembly.

FIG. 5 is a perspective view of the combination monitor and microphone apparatus of FIG. 1 showing a microphone coupled to a portion of a boom assembly and a speaker of a monitor assembly directed towards a performer.

FIG. 6 is a perspective view of the combination monitor and microphone apparatus of FIG. 5 showing the microphone coupled to a portion of the boom assembly directed towards the performer and the speaker of the monitor assembly directed away from the performer.

### DESCRIPTION OF THE INVENTION

According to FIG. 1, in one embodiment of a combination monitor and microphone apparatus 10, the apparatus 10 comprises a microphone 12, a boom assembly 14 having a first boom portion 16 and a second boom portion 18 coupled to the microphone 12. The apparatus 10 further comprises clamping means 20 located at one end of the first boom portion 16 for permitting selective coupling to the microphone 12 and an opposite end of the first boom portion 16 that is telescopically coupled to one end of the second boom portion 18. The clamping means 20 located at one end of the first boom portion 16 comprises a microphone clamp 38 having an opening for retaining at least a portion of the microphone 12. The microphone clamp 38 is adapted to axially rotate the microphone 12 thereby permitting adjustment of the microphone 12 for optimum use by a performer during a performance.

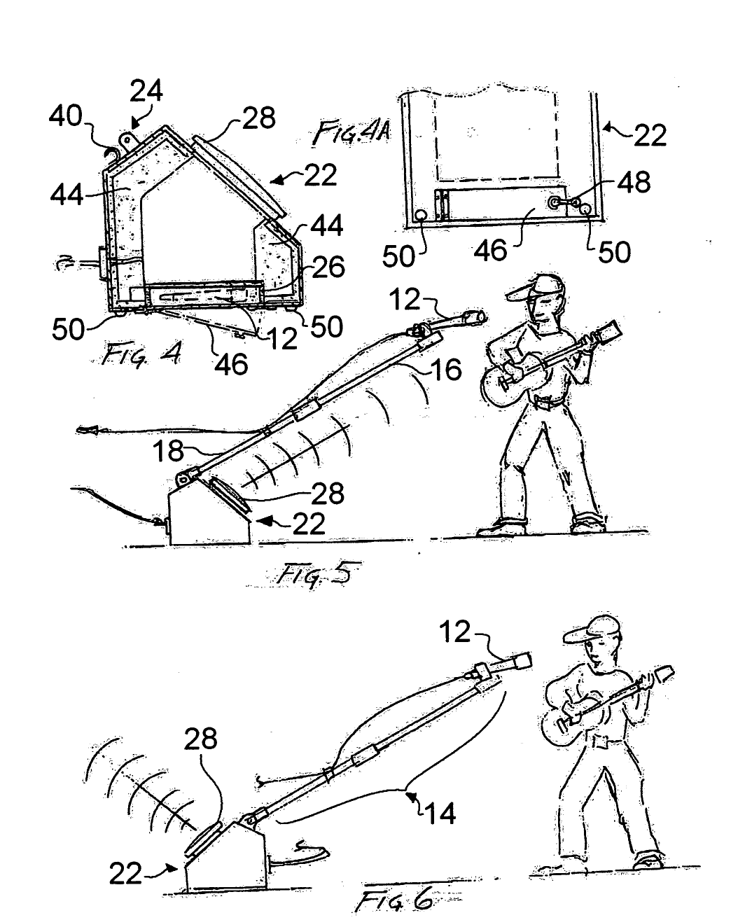

With reference to FIG. 1, the combination monitor and microphone apparatus 10 also comprises a monitor assembly 22 including boom clamping means 24 located on a portion of the monitor assembly 22 for coupling the monitor assembly 22 to an opposite end of the second boom portion 18 of the boom assembly 14. In FIG. 1 (and also shown in FIG. 2) in this embodiment of the apparatus 10, the boom clamping means comprises a boom clamp 36 having a member 34 for receiving a portion of the opposite end of the second boom portion 18 of the boom assembly 18. It is understood that various types of boom clamping means are possible, such as the opposite end of the boom assembly 18 having an opening for receiving a pin which passes through an alternative boom clamp located on a portion of the monitor assembly 22, without the alternative boom clamp having the member 36. The boom clamping means 24 is adapted to axially rotate the boom assembly 14. A housing 26 is located in a portion of the monitor assembly 22 (see FIG. 4). The housing 26 accommodates at least a portion of the microphone 12 when the combination monitor and microphone apparatus 10 is not used by the performer. A speaker 28 is located on a portion of the monitor assembly 22. The boom assembly 14 is selectively rotated in a direction to permit the performer to listen to sound emanating from the speaker 28 (see FIG. 5) such as during a performance and to permit at least one other person to listen to sound emanating from the speaker 28 when the boom assembly 14 is rotated in another direction (see FIG. 6). It is understood that the at least one other person may be at least one other performer on a stage or an audience.

Referring again to FIG. 1 the monitor assembly 22 has at least one handle 30 on a portion of the monitor assembly 22 thereby permitting portable removal of the combination monitor and microphone apparatus 10 from the stage after completion of the performance. In addition, during the performance the at least one handle 30 facilitates movement by a person of the combination monitor and microphone apparatus 10 on a portion of a surface of the stage. According to FIG. 1, a first handle 30 is shown on a front side of the monitor assembly 22, and a second handle 32 is shown on an adjacent side of the monitor assembly 22. It is understood that any suitable side of the monitor assembly 22 may have at least one handle (of the type shown as 30 and 32 in FIG. 1).

Turning now to FIG. 2, the monitor assembly 22 has at least one clip 40 on a portion of the monitor assembly 22 for receiving the boom assembly 14 when the combination monitor and microphone apparatus 10 is not used by the performer such as after completion of the performance. It is understood that the at least one clip 40 may be partially open as shown in FIG. 2 (and also in FIG. 4) or may comprise a latching configuration which encloses the boom assembly 14. In FIGS. 2, 5 and 6, the monitor assembly 22 is coupled to a public address system (not shown) and the microphone 12 is coupled to the public address system (not shown). It is understood that the microphone 12 and speaker 28 of the monitor assembly 22 may also be wirelessly coupled to the public address system.

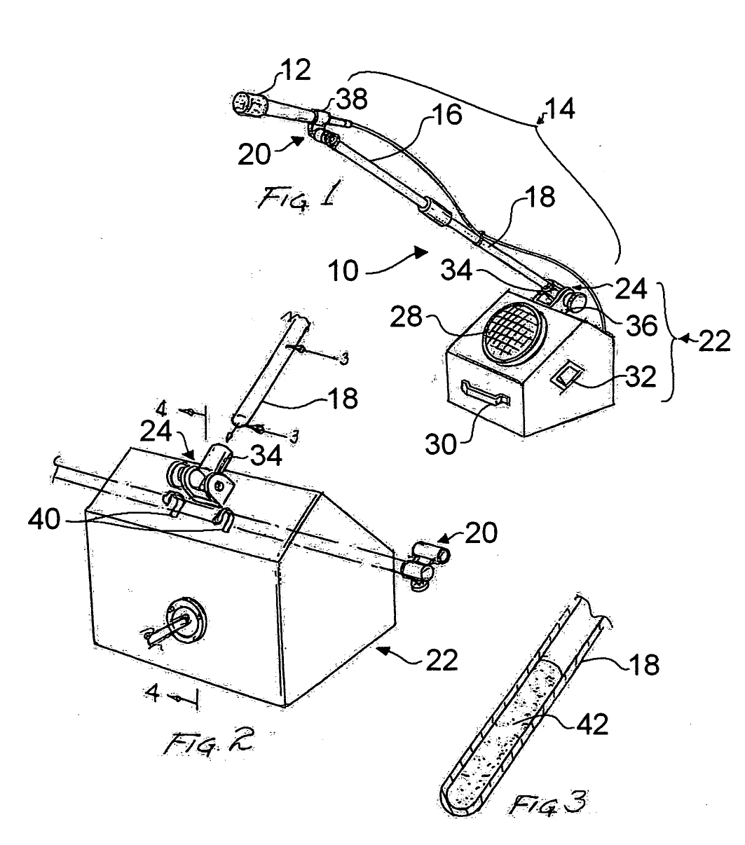

Referring to FIG. 3, an inner portion of the opposite end of the second boom portion 18 includes a vibration dampening material 42. The vibration dampening material 42 comprises at least one viscoelastic polymer. The vibration dampening material 42 may comprise a foamed polymer such as polyurethane and the like or a polymer comprising a plurality of microspheres. The vibration dampening material 42 lessens objectionable sound vibration feedback during the performance.

FIG. 4 is a sectional view through 4-4 of FIG. 2. According to FIG. 4, the speaker 28 of the monitor assembly 22 is coupled to an inner portion of the monitor assembly 22. The inner portion of the monitor assembly 22 includes a vibration dampening material 44, which may be the same as vibration dampening material 42 in the inner portion of the second boom portion 18. The vibration dampening material 44 comprises at least one viscoelastic polymer. The housing 26 located in a portion of the monitor assembly 22 (shown in a bottom portion of the monitor assembly 22 in FIG. 4) has a cover 46 for retaining the microphone 12 in the housing 26 thereby enclosing at least a portion of the microphone 12 in the housing 26 when the microphone 12 is not used after completion of the performance. FIG. 4A shows a portion of the bottom side of the monitor assembly 22 with the cover 46 in a closed position. The cover 46 may have a lock and key mechanism 48 for securely retaining the cover 46 to the bottom side of the monitor assembly 22. The cover 46 may also have a tab thereby facilitating opening and closing of the housing 26. The bottom side of the monitor also comprises a plurality of slides 50 (also shown in FIG. 4), which both facilitate movement and also improve stability of the combination monitor and microphone apparatus 10 on a portion of the surface of the stage during the performance.

In using the combination monitor and microphone apparatus 10, a method for permitting the performer and at least one other person to listen to sound emanating from the combination monitor and microphone apparatus 10 comprises the steps of providing clamping means 20 located at one end of the first boom portion 16 of the boom assembly 14 for permitting selective coupling to the microphone 12 and an opposite end of the first boom portion 16 of the boom assembly 14 that is telescopically coupled to one end of the second boom portion 18 of the boom assembly 14 and adjusting the boom assembly 14 for the height of the performer. The method further comprises the steps of providing the boom clamping means 24 located on a portion of the monitor assembly 22 for coupling the monitor assembly 22 to an opposite end of the second boom portion 18 is adapted to axially rotate the boom assembly 14 and providing the housing 26 located in a portion of the monitor assembly 22 accommodates at least a portion of the microphone 12 when the combination monitor and microphone apparatus 10 is not used by the performer The method further comprises the steps of selectively rotating the boom assembly 14 in a direction to permit the performer to listen to sound emanating from the speaker 28 such as during a performance and selectively rotating the boom assembly 14 in another direction to permit at least one other person to listen to sound emanating from the speaker 28. The method further comprises the steps of repositioning the combination monitor and microphone apparatus 10 with the at least one handle 30 (or 32) located on a portion of the monitor assembly 22 on the stage during the performance thereby facilitating movement by a person of the combination monitor and microphone apparatus 10 on a portion of the surface of the stage and portably removing the combination monitor and microphone apparatus 10 with the at least one handle 30 (or 32) to from the stage after completion of the performance. The method further comprises the steps of decoupling the boom assembly 14 from the at least one clip 38 on a portion of the monitor assembly 22 when the monitor and microphone apparatus 10 is used by the performer during the performance and coupling the boom assembly 14 from the at least one clip 38 on a portion of the monitor assembly 22 which receives the boom assembly 14 when the combination monitor and microphone apparatus 10 is not used by the performer after completion of the performance. The method further comprises the steps of retrieving the microphone 12 from the housing 26 for use during the performance, coupling the microphone 12 to the clamping means 20, and decoupling the microphone 12 from the clamping means 20 and replacing the microphone 12 in the housing 26 after completion of the performance. The method further comprises the steps of coupling the public address system (not shown) to both the monitor assembly 22 and the microphone 12 during a performance, and decoupling the monitor assembly 22 and the microphone 12 from the public address system after completion of the performance.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A combination monitor and microphone apparatus comprising, in combination:
a microphone;
a boom assembly having a first boom portion and a second boom portion coupled to said microphone;
clamping means located at one end of said first boom portion for permitting selective coupling to said microphone and an opposite end of said first boom portion that is telescopically coupled to one end of said second boom portion;
a monitor assembly including boom clamping means located on a portion of said monitor assembly for coupling said monitor assembly to an opposite end of said second boom portion, said boom clamping means adapted to axially rotate said boom assembly;
a housing located in a portion of said monitor assembly, said housing accommodating at least a portion of said microphone when said combination monitor and microphone apparatus is not used by a performer; and
a speaker located on a portion of said monitor assembly, said boom assembly selectively rotated in a direction to permit the performer to listen to sound emanating from said speaker such as during a performance and to permit at least one other person to listen to sound emanating from said speaker when said boom assembly is rotated in another direction.

2. The combination monitor and microphone apparatus according to claim 1 further comprising said monitor assembly having at least one clip on a portion of said monitor assembly for receiving said boom assembly when said combination monitor and microphone apparatus is not used by the performer.

3. The combination monitor and microphone apparatus according to claim 1 further comprising said monitor assembly having at least one handle on a portion of said monitor assembly thereby permitting both portable removal of said combination monitor and microphone apparatus from a stage, and facilitating movement by a person of said combination monitor and microphone apparatus on a portion of a surface of said stage.

4. The combination monitor and microphone apparatus according to claim 1 wherein an inner portion of said opposite end of said second boom portion including a vibration dampening material.

5. The combination monitor and microphone apparatus according to claim 1 wherein said speaker of said monitor assembly coupled to an inner portion of said monitor assembly, said inner portion of said monitor assembly including a vibration dampening material.

6. The combination monitor and microphone apparatus according to claim 4 wherein said vibration dampening material comprises at least one viscoelastic polymer.

7. The combination monitor and microphone apparatus according to claim 5 wherein said vibration dampening material comprises at least one viscoelastic polymer.

8. The combination monitor and microphone apparatus according to claim 1 wherein said clamping means located at one end of said first boom portion comprising a microphone clamp having an opening for retaining at least a portion of said microphone, said microphone clamp adapted to axially rotate said microphone thereby permitting adjustment of the microphone for optimum use by the performer during a performance.

9. The combination monitor and microphone apparatus according to claim 1 wherein said boom clamping means comprising a boom clamp having a member for receiving a portion of said opposite end of said second boom portion.

10. The combination monitor and microphone apparatus according to claim 1 wherein said housing having a cover for retaining said microphone in said housing thereby enclosing at least a portion of said microphone in said housing when said microphone is not used after completion of a performance.

11. The combination monitor and microphone apparatus according to claim 1 wherein said monitor assembly is coupled to a public address system and said microphone is coupled to said public address system.

12. A method for permitting a performer and at least one other person to listen to sound emanating from a combination monitor and microphone apparatus comprising the steps of:
providing a microphone;
providing a boom assembly having a first boom portion and a second boom portion coupled to said microphone;
providing clamping means located at one end of said first boom portion for permitting selective coupling to said microphone and an opposite end of said first boom portion that is telescopically coupled to one end of said second boom portion;
providing a monitor assembly including boom clamping means located on a portion of said monitor assembly for coupling said monitor assembly to an opposite end of said second boom portion, said boom clamping means adapted to axially rotate said boom assembly;
providing a housing located in a portion of said monitor assembly, said housing accommodating at least a portion of said microphone when said combination monitor and microphone apparatus is not used by a performer;
providing a speaker located on a portion of said monitor assembly;
selectively rotating said boom assembly in a direction to permit the performer to listen to sound emanating from said speaker such as during a performance; and
selectively rotating said boom assembly in another direction to permit at least the one other person to listen to sound emanating from said speaker.

13. The method according to claim 12 further comprising the steps of:
providing said monitor assembly having at least one handle on a portion of said monitor assembly;
repositioning said combination monitor and microphone apparatus with said at least one handle on a stage during a performance thereby facilitating movement by a person of said combination monitor and microphone apparatus on a portion of a surface of said stage;
providing said monitor assembly having at least one clip on a portion of said monitor assembly for receiving said boom assembly when said combination monitor and microphone apparatus is not used by the performer after completion of the performance; and
portably removing said combination monitor and microphone apparatus with said at least one handle from said stage after completion of the performance.

14. The method according to claim 12 further comprising the steps of:
providing an inner portion of said opposite end of said second boom portion including a vibration dampening material;
providing said speaker of said monitor assembly coupled to an inner portion of said monitor assembly, said inner portion of said monitor assembly including an other vibration dampening material; and
providing both said vibration dampening material and said other vibration dampening material comprising at least one viscoelastic polymer.

15. The method according to claim 12 further comprising the steps of:
providing said housing having a cover for retaining said microphone in said housing thereby enclosing at least a portion of said microphone in said housing;
retrieving said microphone from said housing for use during a performance; and
replacing said microphone in said housing after completion of the performance.

16. The method according to claim 12 further comprising the steps of:
providing said monitor assembly is coupled to a public address system and said microphone is coupled to said public address system during a performance; and
decoupling said monitor assembly and said microphone from said public address system after completion of the performance.
